(19) United States
(12) Patent Application Publication
(10) Pub. No.: US 2014/0203939 A1
(43) Pub. Date: Jul. 24, 2014

(54) CONTROL AND MONITORING OF LIGHT-EMITTING-DIODE (LED) BULBS

(71) Applicant: RTC Inc., Dexter, MI (US)

(72) Inventors: Richard H. Harrington, Dexter, MI (US); Charles W. Krapf, Livonia, MI (US)

(73) Assignee: RTC INC., Dexter, MI (US)

(21) Appl. No.: 14/160,160

(22) Filed: Jan. 21, 2014

Related U.S. Application Data
(60) Provisional application No. 61/754,662, filed on Jan. 21, 2013.

(51) Int. Cl. H05B 33/08; H04M 11/04; G08B 17/103

(52) U.S. Cl. CPC H05B 33/0845; G08B 17/103; H04M 11/04
USPC 340/584; 315/307; 315/158

(57) ABSTRACT

A smart light-emitting-diode (LED) bulb includes apparatus enabling the bulb to be turned ON, OFF, or dimmed without the use of a wall switch. Such apparatus may include circuitry responsive to rotating the LED portion of the bulb, circuitry responsive to touching or tapping on the bulb, or a Bluetooth or WiFi interconnection enabling the bulb to be controlled using a smartphone or other device executing a bulb-control application. Other apparatus may include a microphone enabling the bulb to be controlled with a voice, sound or music. In other embodiments, apparatus enabling the bulb to be turned ON, OFF, or dimmed may include a power line communication (PLC) interface enabling the bulb or bulbs to be controlled via the Internet. A camera or image sensor may be provided enabling the bulb to be gesture-controlled. A system may include a plurality of smart LED light bulbs.

### REFERENCE TO RELATED APPLICATION

This application claims priority from U.S. Provisional Patent Application Ser. No. 61/754,662, filed Jan. 21, 2013, the entire content of which is incorporated herein by reference.

### FIELD OF THE INVENTION

This invention relates generally to light-emitting-diode (LED) bulbs and, in particular, to improvements in the control and monitoring of LED bulbs.

### BACKGROUND OF THE INVENTION

Light-emitting-diode (LED) lamps offer long service life and high energy efficiency. While initial costs are currently higher than those of fluorescent and incandescent lamps, prices are expected to fall dramatically in the coming years. LED lamps are now made to replace screw-in incandescent or compact fluorescent light bulbs. Most LED lamps replace incandescent bulbs rated from 5 to 60 watts, though again, much higher wattages and brightness are anticipated.

Incandescent bulbs have a typical life of 1,000 hours, compact fluorescents about 8,000 hours. LED bulbs are more power-efficient than compact fluorescent bulbs and offer lifespans of 30,000 or more hours, reduced if operated at a higher temperature than specified. Indeed, the higher purchase cost compared to other types of bulbs may already be more than offset by savings in energy and maintenance.

LED bulbs maintain output light intensity well over their life-times, and they are also mercury-free, unlike fluorescent lamps. LED lamps are also available with a variety of color properties. Several companies offer LED lamps for general lighting purposes. The technology is improving rapidly and new energy-efficient consumer LED lamps are available. Some models of LED bulbs work with dimmers of the type used for incandescent lamps.

### SUMMARY OF THE INVENTION

This invention relates generally to light-emitting-diode (LED) bulbs and, in particular, to improvements in the control and monitoring of LED bulbs. A smart light-emitting-diode (LED) bulb according to certain embodiments includes a base portion that screws into a conventional light-bulb socket, a light-emitting portion that includes one or more LEDs, and apparatus enabling the bulb to be turned ON, OFF, or dimmed without the use of a wall switch.

Apparatus enabling the bulb to be turned ON, OFF, or dimmed may include circuitry responsive to rotating the LED portion of the bulb. Apparatus enabling the bulb to be turned ON, OFF, or dimmed may include circuitry responsive to touching or tapping on the bulb. Alternative apparatus may include a Bluetooth or WiFi interconnection enabling the bulb to be controlled using a smartphone or other device executing a bulb-control application. Further apparatus enabling the bulb to be turned ON, OFF, or dimmed includes a microphone enabling the bulb to be controlled with a voice, sound or music.

In other embodiments, apparatus enabling the bulb to be turned ON, OFF, or dimmed may include a power line communication (PLC) interface enabling the bulb or bulbs to be controlled via the Internet. A camera or image sensor may be provided enabling the bulb to be gesture-controlled.

A system may include a plurality of light bulbs, each including a base portion that screws into a conventional light-bulb socket and a light-emitting portion that includes one or more LEDs. A wireless mesh network may enable each bulb to measure temperature and light output, enabling each bulb to function as a fire detector. A smart phone may be programmed to call 911 with a pre-programmed message in the event that one of the bulbs detects a fire. The bulbs may include a light sensor operative to detect a modulated light intensity as fire produces irregular light output. An interface may be provided enabling each bulb to generate a status report regarding bulb temperature, current draw or intensity.

### BRIEF DESCRIPTION OF THE DRAWINGS

FIG. 1 shows an LED bulb with a rotating top to effectuate dimming;

FIG. 2 illustrates the use of a MEMS sensor to determine the angular position and adjust the brightness of an LED bulb;

FIG. 3 illustrates the use of a shaft encoder or potentiometer to determine the angular position and adjust the brightness of an LED bulb;

FIG. 4 depicts the implementation of a Bluetooth or WiFi connection;

FIG. 5 shows the use of a wireless Bluetooth or WiFi connection;

FIG. 6 illustrates the use of a power line communications (PLC) controller;

FIG. 7 illustrates a smartphone-enabled system incorporating an optional IR LED, camera and microphone to construct a baby monitor, for example;

FIG. 8 illustrates an Internet-enabled system incorporating an optional IR LED, camera and microphone to construct a security system, for example; and

FIG. 9 depicts a Bluetooth- or WiFi-enabled system controlling a plurality of smart LED bulbs.

### DETAILED DESCRIPTION OF THE INVENTION

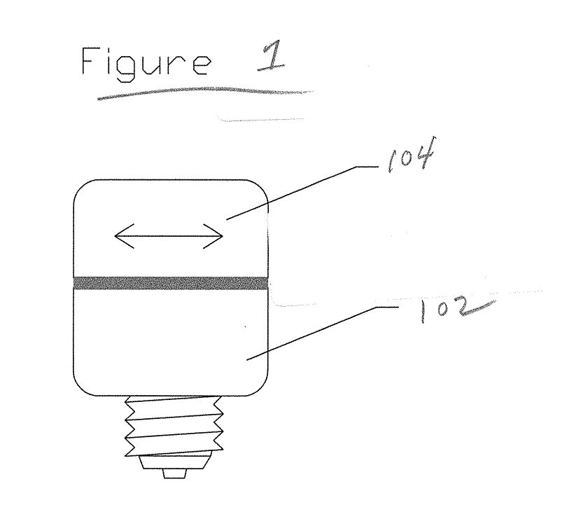

This invention improves upon existing LED bulb technology by providing various control and monitoring options. In terms of control, since LED bulbs are not overly hot to the touch, a novel way to control the LED bulb is to turn a portion of the entire bulb. As shown in FIG. 1, the bulb is provided in two parts, the first part 102 being stationary in the electrical outlet after it is first screwed in. The second part 104, which can rotate relative to the in-socket portion, contains the LEDs. A potentiometer may conveniently be used to detect the degree of rotation and adjust the brightness accordingly using known or yet-to-be developed dimmer technologies.

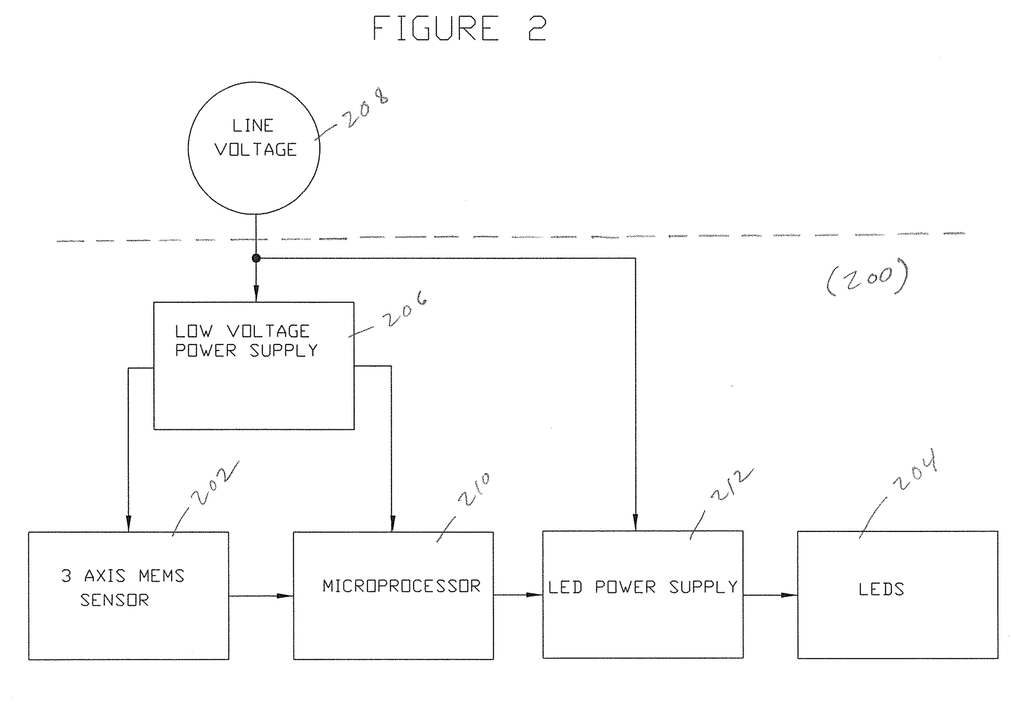

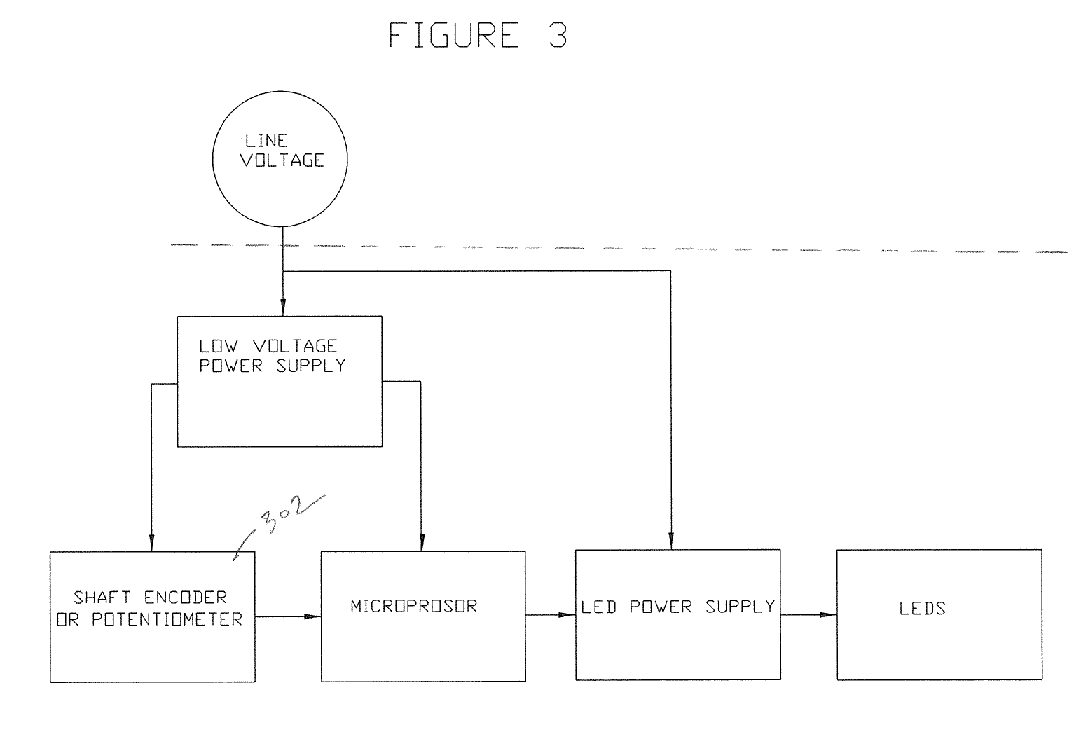

As alternatives, a shaft encoder or a 3-axis (MEMS) tilt sensor may be used to determine the angular position and adjust the brightness. As shown in FIG. 2, a 3-axis MEMS sensor 202 allows the bulb 204 to be in any position and still recognize the relative rotation of the bulb. Turning the bulb will adjust its brightness from full on to totally off. In this embodiment, a low-voltage power supply 206 connected to the AC line 208 provides power to a microprocessor 210 that receives a signal from the 3-axis MEMS sensor 202 to control a higher power LED supply 212. The LED supply 212 controls the LEDs 204 from the AC line based upon the dimmer signals received from the micro 210. FIG. 3 illustrates how a shaft encoder 302 may be used in place of the MEMS tilt sensor of FIG. 2. Note that in FIGS. 2 and 3 and the remaining Figures, the components below the broken line, (200), for example, are all contained in the LED bulb adapted to be screwed into a socket or otherwise coupled to line voltage.

Tapping the bulb is yet another way to adjust brightness in accordance with the invention. As one example, tapping the bulb at the zero degree point of the accelerometer or 3-axis tilt sensor will turn the bulb down or off depending on embedded microprocessor programming. Tapping the bulb at the 90 degree point of the accelerometer or 3-axis tilt sensor may adjust it to 25 percent brightness, for example. Tapping the bulb at the 180 degree point of the accelerometer or 3 axis tilt sensor will adjust it to 50 percent, and tapping the bulb at the 270 degree point of the accelerometer or 3-axis tilt sensor will adjust it to 75 percent brightness. Tapping the bulb at the 330 degree point of the accelerometer or 3 axis tilt sensor will adjust it to 100 percent brightness.

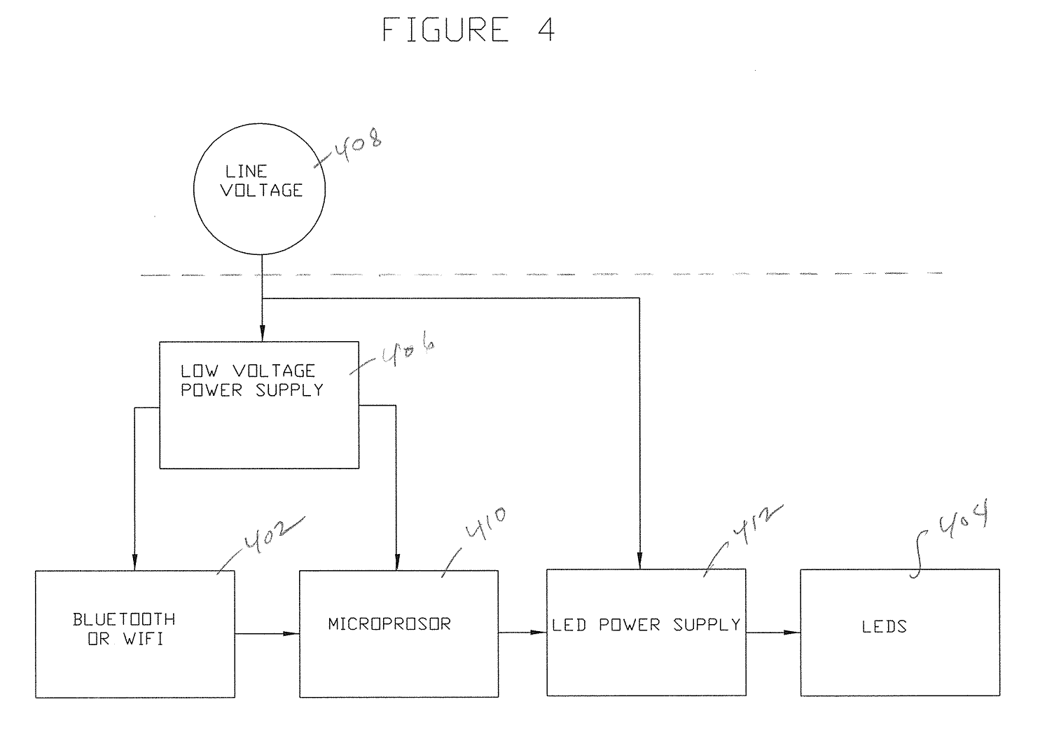

As a different control option, a smartphone with Bluetooth or WiFi may be used to control the LED bulbs using a specially written application for a smart phone, for example. As shown in FIG. 4, such an LED bulb will be equipped with a Bluetooth radio or WiFi interface. In this embodiment, a low-voltage power supply 406 connected to the AC line 408 provides power to the Bluetooth radio or WiFi interface 402 and a microprocessor 410 that receives a signal from block 402 to control a higher power LED supply 412. The LED supply 412 controls the LEDs 404 from the AC line 408 based upon the dimmer signals received from the micro 410.

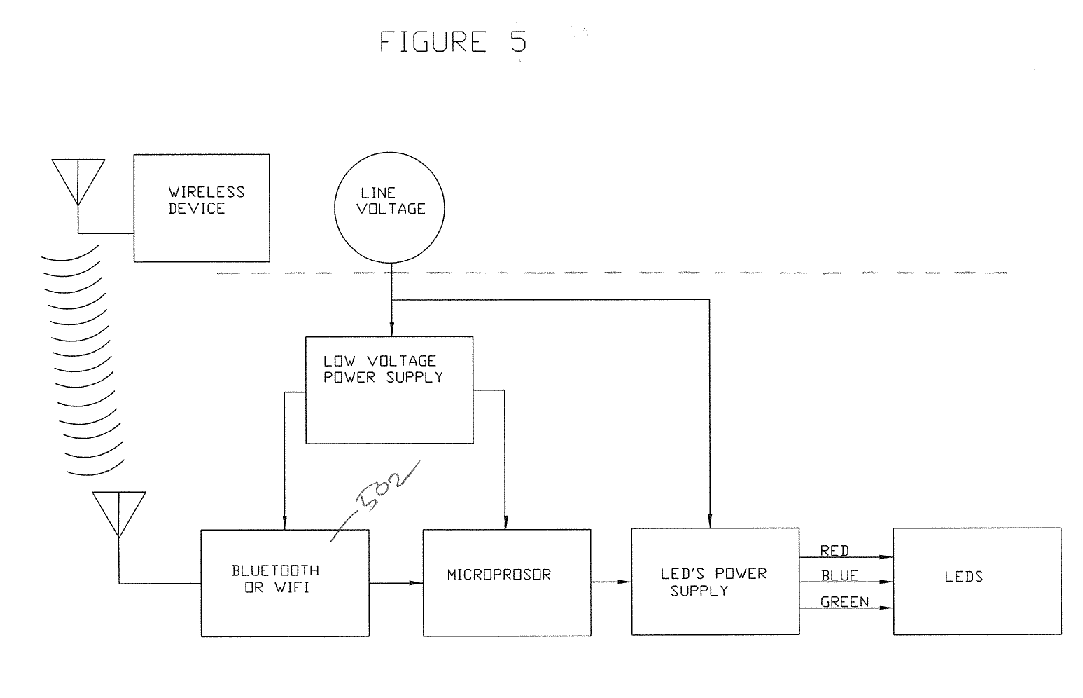

FIG. 5 illustrates the use of a wireless signal received by a Bluetooth or WiFi interface 502. When it is first plugged in, the bulbs in FIGS. 4 and 5 will be ‘found’ and ‘connected’ to the iPHONE, smartphone or other device. The device application will ask for name to be assigned to that LED bulb. Once it has a Name (ID), the bulb may be controlled by the phone application in many ways, such as a voice command (i.e., “Hall Light On”). Intensity may be adjusted by a voice command such as “Hall Light 50% Brightness.” If the LED Bulb is multicolor, it can be commanded to a specific color using a voice command such as “Hall Light Warm White.”

The use of a smart application may further be used to modulate both the intensity and the color by talking or singing into the phone. The color will track the frequency, and the intensity of the bulb will track the voice volume. Yet another attribute of this design is to have the smartphone use its “music” function to control the color and intensity of the bulb(s). The effect in this case will be that of a ‘color organ.’

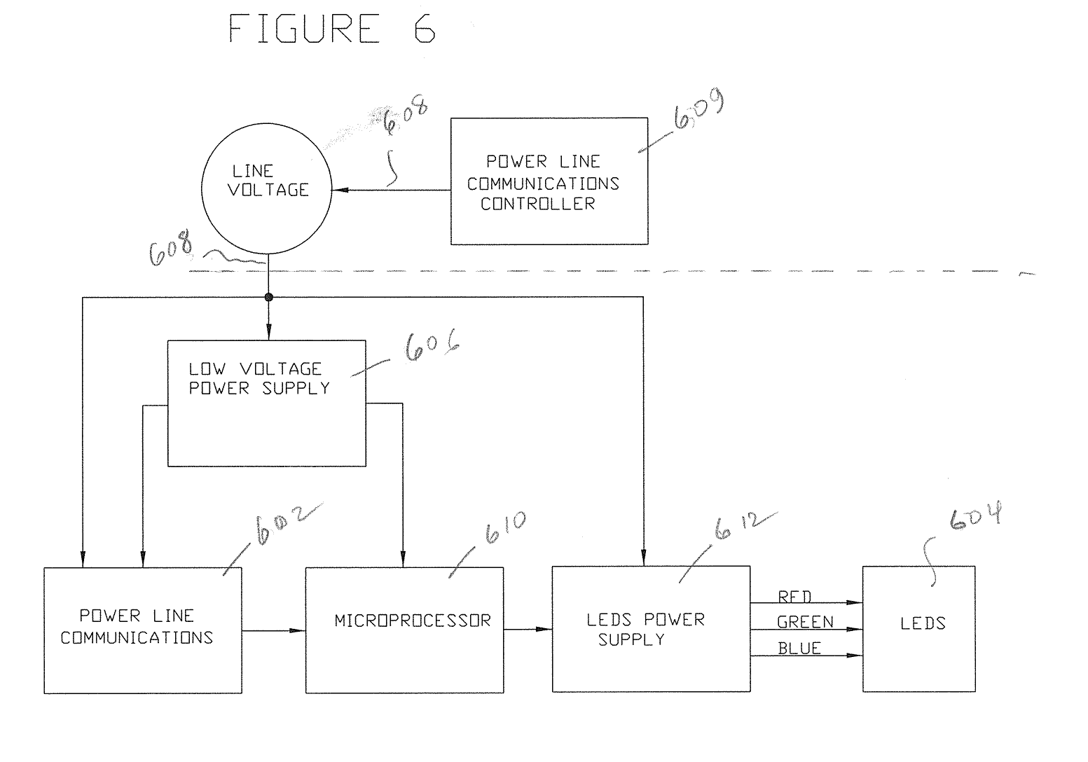

Yet another control function involves the use of the Internet to control a smart bulb. In this embodiment, depicted in FIG. 6, a home or office computer would be equipped with power line communication (PLC 609) that sends digital or analog data over the power line 608. The LED bulb would also have PLC 602 built in, such that each smart bulb responds to its ID and changes its intensity and or color according to the commands sent over the NET. In this way, a house or office, factory can help prevent theft by turning on and off the smart bulbs at appropriate times. As with FIGS. 2-5, a low-voltage power supply 606 connected to the AC line 608 provides power to the PLC interface 602 and a microprocessor 610 that receives a signal from block 602 to control a higher power LED supply 612. The LED supply 612 controls the LEDs 604 from the AC line 608 based upon the signals received from the micro 510.

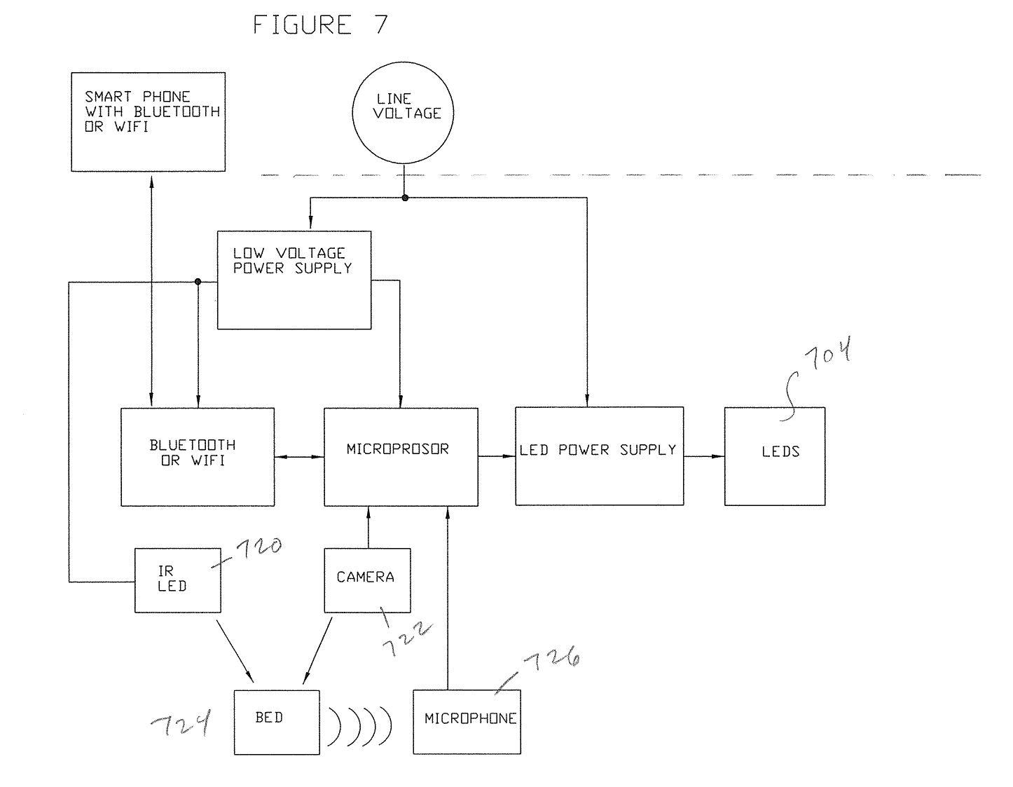

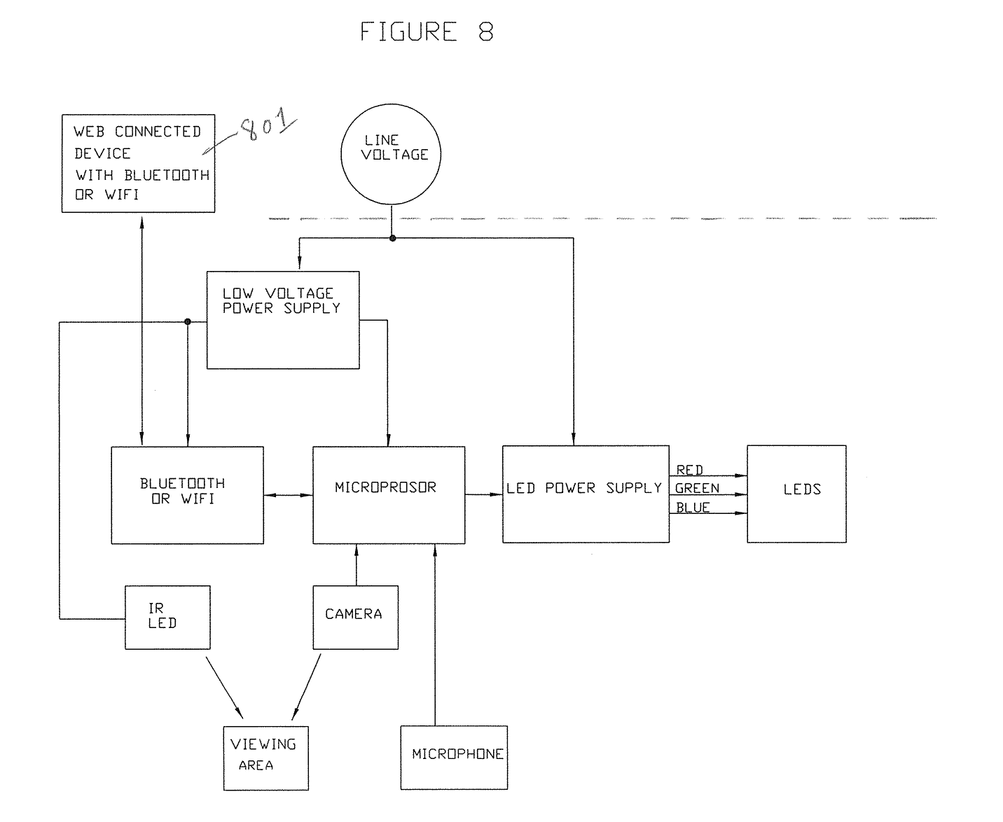

A smart Bluetooth LED bulb may also have a build-in microphone that can be used as a baby monitor, or as an intrusion alert. FIG. 7 illustrates a smart phone implementation. FIG. 8 shows the data may be communicated over a Bluetooth radio or via PLC to a computer or other device 801 that is web connected. In addition to a microphone, the smart bulb can also have a camera for use as the baby monitor and or the intrusion alert. As shown in FIG. 7, for example, an infrared (IR) LED 720 may be used so that it is invisible to humans, but can be seen with a camera 722 equipped with this capability. This would be valuable for a baby monitor, as it would not interfere with a baby's sleep. The sound that the microphone 726 picks up may be transmitted over the web to a computer with sound pattern recognition that could then be programmed to open or close a door, call a phone, or simple turn the LEDs 704 on or off. An optional speaker phone could be activated such that a simple “HELP” command could activate a 911 call.

Another way to turn the light ON and OFF is to use gestures that a camera sees and a microprocessor recognizes. The circuits of FIGS. 7 and 8 are applicable to this embodiment. The micro may be pre-programmed to recognize gesture recognition, and may also have the ability to be taught new gestures to control brightness and color. In addition to hand gestures, movement alone could be used to turn on the LEDs. This could be used as a convenience and also as an anti-theft device. The lamp could also be programmed to send a message and or the camera image over the web to a web site used to monitor single or multiple LED bulbs with built in cameras and web access.

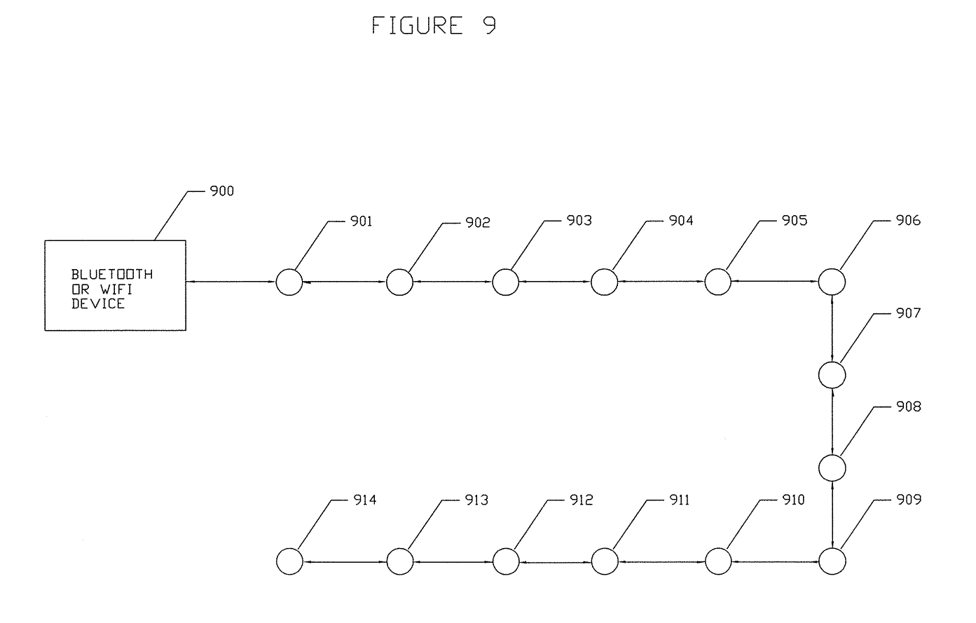

A Network of bulbs can be established by assigning ID's to each bulb and then assigning them to a particular network. FIG. 9 shows how a string of smart LED bulbs 901-914 may be controlled by a Bluetooth or WiFi device 900. A wireless Mesh network would work especially well as the commands are passed from bulb to bulb at RF ranges far beyond the point of command initiation such as the smart phone. Each bulb can send back status such as temperature, current draw and intensity if a light sensor is provided.

Given that each bulb can measure temperature and light output, the bulbs would function as a fire detector and the smart phone could be programmed to call 911 with a pre-programmed message. The light sensor would see a modulated light intensity as fire produces irregular light output.

1. A smart light-emitting-diode (LED) bulb, comprising:
a base portion that screws into a conventional light-bulb socket;
a light-emitting portion that includes one or more LEDs; and
apparatus enabling the bulb to be turned ON, OFF, or dimmed without the use of a wall switch.

2. The smart LED bulb of claim 1, including apparatus enabling the bulb to be turned ON, OFF, or dimmed by rotating the LED portion of the bulb.

3. The smart LED bulb of claim 1, including apparatus enabling the bulb to be turned ON, OFF, or dimmed by touching or tapping on the bulb.

4. The smart LED bulb of claim 1, wherein the apparatus enabling the bulb to be turned ON, OFF, or dimmed includes a Bluetooth or WiFi interconnection enabling the bulb to be controlled using a smartphone or other device executing a bulb-control application.

5. The smart LED bulb of claim 1, wherein the apparatus enabling the bulb to be turned ON, OFF, or dimmed includes a microphone enabling the bulb to be controlled with a voice, sound or music.

6. The smart LED bulb of claim 1, wherein the apparatus enabling the bulb to be turned ON, OFF, or dimmed includes a power line communication (PLC) interface enabling the bulb or bulbs to be controlled via the Internet.

7. The smart LED bulb of claim 1, wherein the apparatus enabling the bulb to be turned ON, OFF, or dimmed includes a camera or image sensor enabling the bulb to be gesture-controlled.

8. A smart light-emitting-diode (LED) bulb system, comprising:
a plurality of light bulbs, each including a base portion that screws into a conventional light-bulb socket and a light-emitting portion that includes one or more LEDs; and
a wireless mesh network enabling each bulb to measure temperature and light output, enabling each bulb to function as a fire detector.

9. The system of claim 8, including a smart phone programmed to call 911 with a pre-programmed message in the event that one of the bulbs detects a fire.

10. The system of claim 8, including a light sensor operative to detect a modulated light intensity as fire produces irregular light output.

11. The system of claim 8, including an interface enabling each bulb to generate a status report regarding bulb temperature, current draw or intensity.
